(19) United States
(12) Patent Application Publication
(10) Pub. No.: US 2024/0362536 A1
(43) Pub. Date: Oct. 31, 2024

(54) AUTOMATED TRAINING BASED DATA LABELING METHOD

(71) Applicant: datamaker, Daejeon (KR)

(72) Inventor: Enoch Lee, Daejeon (KR)

(21) Appl. No.: 18/642,635

(22) Filed: Apr. 22, 2024

(30) Foreign Application Priority Data
Apr. 28, 2023 (KR) 10-2023-0056383

(51) Int. Cl. G06N 20/00

(52) U.S. Cl. CPC G06N 20/00

(57) ABSTRACT

An automated training-based data labeling method according to the present disclosure is configured to generate an artificial intelligence model in which a processor separates some of labeled data into training data as soon as it receives a certain amount of labeled data from a worker terminal, and automatically performs the data labeling on objects in source data through automated training of the training data. According to the present disclosure, since a proportion of worker participation is reduced when labeling the data for the objects in the source data, it is possible to dramatically reduce operation costs required for the data labeling.

### CROSS-REFERENCE TO RELATED APPLICATIONS

This application claims foreign priority to Korean Patent Application No. 10-2023-0056383, filed Apr. 28, 2023, the content of which is incorporated by reference herein in its entirety.

### TECHNICAL FIELD

The disclosed technology relates to an automated training-based data labeling method that automatically trains label data to improve data labeling efficiency of a worker.

### BACKGROUND

Performance of artificial intelligence depends on the amount of training and quality of data, and at least 1 million pieces of data per class are required to achieve human-level performance. As the artificial intelligence market expands, labeling a large amount of data is essential for the development of various artificial intelligence models, but the cost of data labeling is becoming a problem compared to the amount of training and quality of data required. That is, since the data labeling requires a manpower-based operation, it is difficult to apply techniques to reduce the cost of data labeling regardless of labeling the small amount of data or labeling the large amount of data, and since the data quality control becomes more difficult as the large amounts of data are handled, not only may economy of scale not be achieved, but the cost of data labeling may increase.

In addition, labor costs may be reduced by causing workers in English-speaking countries, India, or third world English-speaking countries to perform data labeling. However, in order to perform data labeling of Korean data, Korea-specific image data, or the like, there is no choice but to hire Koreans. However, in this case, it is difficult to label a large amount of data due to labor cost issues.

Therefore, in order to perform the data labeling more efficiently, intervention of workers should be minimized during the data labeling. To this end, only when the data labeling should be performed based on a program and workers should only perform an operation of checking and correcting the results of the data labeling performed by the program, the time and labor costs of the entire project may be reduced.

Meanwhile, some companies have developed a preprocessing engine and are utilizing the preprocessing engine to process a large amount of data. However, when the performance of the preprocessing engine deteriorates, the quality of data preprocessed by the preprocessing engine is bound to be low. When the quality of the preprocessed data deteriorates, workers should perform the data labeling while modifying the preprocessed data, which may consume more time than when the workers perform the data labeling without the preprocessing engine.

Typical artificial intelligence companies develop one or two artificial intelligence models and focus on improving the performance of the artificial intelligence models. However, in the case of companies that perform the data labeling, the companies should deal with data for various domains (drones, autonomous driving, walking aids, agriculture, medical care, living, content, etc.), and even if the purpose is the same, objects to be trained for each domain may be different. Companies that aim at object recognition, for example, companies researching an autonomous driving system will want to recognize vehicles, pedestrians, obstacles, roads, etc., as objects, and companies related to fashion items will want to recognize tops, bottoms, accessories, etc., as objects in photos of people.

Due to the nature of data labeling business which performs at least dozens of projects simultaneously, it is very difficult to design and develop artificial intelligence models suitable for each project. In addition, considering the time and labor costs invested in the design and development of the artificial intelligence models, it may result in higher costs compared to the case where the artificial intelligence models are not utilized for the data labeling.

Conventionally, when workers perform data labeling on a large amount of data belonging to a project to generate a vast amount of labeled data, artificial intelligence developers were developing artificial intelligence models that automatically perform data labeling utilizing the vast amount of labeled data. However, if the artificial intelligence models are developed in this way, when a plurality of projects are performed simultaneously, since the artificial intelligence developers should be deployed to each project to design and develop the artificial intelligence models for each project, there is a problem in that it takes too much time and cost to generate artificial intelligence models suitable for a plurality of projects.

Meanwhile, the following patent document discloses a method of training a deep learning multi-layer neural network model using a plurality of unlabeled training data, and a deep learning system performing the method.

KR 10-2017-0083419 A (Jul. 18, 2017)

### SUMMARY

The disclosed technology provides a method of continuously improving data labeling efficiency of a worker by automatically training artificial intelligence based on data labeled by the worker without intervention of an artificial intelligence developer and generating a preprocessing engine automatically performing data labeling based on an artificial intelligence model generated through the automated training.

In addition, the present disclosure provides a method of achieving a time at which a preprocessing engine is introduced into a worker terminal and a pace at which the preprocessing engine is improved at a relatively fast pace.

Further, the present disclosure provides a method of reducing time and cost required for data labeling when labeling data for a plurality of new projects.

However, the technical problem to be solved by the present disclosure is not limited to the above-described problem, and other problems not described can be clearly understood by those skilled in the art from the description of the disclosure described below.

According to a first embodiment of the present disclosure, an automated training-based data labeling method performed by a processor executing one or more instructions stored in memory may include: (a) transmitting a plurality of source data to a worker terminal; (b) receiving, from the worker terminal, first-round labeled data for which data labeling is performed on objects in first-round source data among the plurality of source data; (c) generating a first-round artificial intelligence model that automatically performs the data labeling on the objects in the source data by separating some of the first-round labeled data into first-round training data and training an artificial neural network through the first-round training data; (d) receiving, from the worker terminal, nth-round labeled data for which the data labeling is performed on objects in nth-round source data among the plurality of source data; (c) generating an nth-round artificial intelligence model that automatically performs the data labeling on the objects in the source data by separating some of the nth-round labeled data into the nth-round training data, and training an n−1th-round artificial neural model through the nth-round training data; and (f) determining whether a preset termination condition is satisfied, and repeatedly performing the steps (d) to (e) until the preset termination condition is satisfied (where the n is a natural number applied in ascending order from 2 based on the number of times the steps (d) and (e) are performed).

The processor may be configured to determine a similarity among the source data to be transmitted to the worker terminal according to a preset similarity determination criterion, and divide the plurality of source data into rounds according to the similarity among the source data and transmits the source data to the worker terminal, and wherein the processor may be configured to include source data with low similarity to each other in the first-round source data transmitted to the worker terminal, and include source data with higher similarity than the similarity among source data included in the first-round source data in the nth-round source data transmitted to the worker terminal.

The number of source data included in the nth-round original data that the processor transmits to the worker terminal may be smaller than the number of source data included in the first-round source data that the processor transmits to the worker terminal.

In the step (c), the processor may separate the remainder of the first-round labeled data into first-round verification data, and calculate performance of the first-round artificial intelligence model utilizing the first-round verification data and determine whether performance of the first-round artificial intelligence model satisfies a preset minimum required performance. When the performance of the first-round artificial intelligence model satisfies the preset minimum required performance, the processor may designate the first-round artificial intelligence model as a preprocessing engine and transmit the preprocessing engine to the worker terminal in order to allow the worker to utilize automated data labeling performed by the preprocessing engine when the worker performs data labeling with the worker terminal. When the performance of the first-round artificial intelligence model does not satisfy the preset minimum required performance, the processor may not designate the first-round artificial intelligence model as a preprocessing engine.

In the step (e), the processor may separate the remainder of the nth-round labeled data into nth-round verification data, and calculate the performance of the first-round artificial intelligence model to the nth-round artificial intelligence model, respectively, utilizing all of the first-round verification data to the nth-round verification data, and select an artificial intelligence model with highest performance among the first-round artificial intelligence model to the nth-round artificial intelligence model. The processor may determine whether performance of the selected artificial intelligence model satisfies the preset minimum required performance, and when the performance of the selected artificial intelligence model satisfies the preset minimum required performance, the processor may designate the selected artificial intelligence model as a preprocessing engine and transmit the preprocessing engine to the worker terminal in order to allow the worker to utilize automated data labeling performed by the preprocessing engine when the worker performs data labeling with the worker terminal. The processor may determine whether performance of the selected artificial intelligence model satisfies the preset minimum required performance, and may not designate the selected artificial intelligence model as a preprocessing engine when the performance of the selected artificial intelligence model does not satisfy the preset minimum required performance.

According to a second embodiment of the present disclosure, an automated training-based data labeling method performed by a processor executing one or more instructions stored in memory may include: (a′) transmitting a plurality of source data to a worker terminal; (b′) receiving, from the worker terminal, first-round labeled data for which data labeling is performed on objects in first-round source data among the plurality of source data; and (c′) generating a first-round artificial intelligence model that automatically performs the data labeling on objects in the source data by separating some of the first-round labeled data into first-round training data and training a prior artificial intelligence model that is pre-trained to automatically perform the data labeling on the objects in the source data through the first-round training data.

In the step (c′), the processor may separate the remainder of the first-round labeled data into first-round verification data, and calculate performance of the prior artificial intelligence model and the first-round artificial intelligence model, respectively, utilizing the first-round verification data, and select an artificial intelligence model with higher performance among the prior artificial intelligence model and the first-round artificial intelligence model. The processor may determine whether the performance of the selected artificial intelligence model satisfies a preset minimum required performance, and when the performance of the selected artificial intelligence model satisfies the preset minimum required performance, the processor designate the selected artificial intelligence model as a preprocessing engine and transmit the preprocessing engine to the worker terminal in order to allow the worker to utilize automated data labeling performed by the preprocessing engine when the worker performs data labeling with the worker terminal. The processor may determine whether the performance of the selected artificial intelligence model satisfies the preset minimum required performance, and may not designate the selected artificial intelligence model as a preprocessing engine when the performance of the selected artificial intelligence model does not satisfy the preset minimum required performance.

The automated training-based data labeling method may further include: after the step (c′), by the processor, (d′) receiving, from the worker terminal, mth-round labeled data for which the data labeling is performed on objects in mth-round source data among the plurality of source data; (e′) generating an mth-round artificial intelligence model that automatically performs the data labeling on the objects in the source data by separating some of the mth-round labeled data into the mth-round training data and training an m−1th-round artificial intelligence model through the mth-round training data; and (f) determining whether a preset termination condition is satisfied, and repeatedly performing the steps (d′) to (e′) until the preset termination condition is satisfied (where the m is a natural number applied in ascending order from 2 based on the number of times the steps (d′) and (e′) are performed).

In the step (e′), the processor may separate the remainder of the mth-round labeled data into mth-round verification data, and calculate the performance of the prior artificial intelligence model, and the first-round artificial intelligence model to the mth-round artificial intelligence model, respectively, utilizing all of the first-round verification data to the mth-round verification data, and select an artificial intelligence model with highest performance among the prior artificial intelligence model, and the first-round artificial intelligence model to the mth-artificial intelligence model. The processor may determine whether the performance of the selected artificial intelligence model satisfies a preset minimum required performance, and when the performance of the selected artificial intelligence model satisfies the preset minimum required performance, the processor may designate the selected artificial intelligence model as a preprocessing engine and transmit the preprocessing engine to the worker terminal in order to allow the worker to utilize automated data labeling performed by the preprocessing engine when the worker performs data labeling with the worker terminal. The processor may determine whether performance of the selected artificial intelligence model satisfies the preset minimum required performance, and may not designate the selected artificial intelligence model as a preprocessing engine when the performance of the selected artificial intelligence model does not satisfy the preset minimum required performance.

### BRIEF DESCRIPTION OF THE DRAWINGS

FIG. 1 is a diagram illustrating a device for performing an automated training-based data labeling method according to the present disclosure together with a worker terminal.

FIG. 2 is a flowchart of an automated training-based data labeling method according to a first embodiment of the present disclosure.

FIG. 3 is a diagram illustrating source data transmitted to a worker terminal.

FIG. 4 is a diagram illustrating source data with relatively low similarity included in first-round source data.

FIG. 5 is a diagram illustrating source data with relatively high similarity included in nth-round source data.

FIG. 6 is a diagram illustrating an appearance in which an artificial neural network and an artificial intelligence model are trained through training data, an appearance in which the artificial intelligence model is verified through verification data, and an appearance in which a preprocessing engine is transmitted to a worker terminal in chronological order, according to the automated training based data labeling method according to the first embodiment of the present disclosure.

FIG. 7 is a flowchart of an automated training based data labeling method according to a second embodiment of the present disclosure.

FIG. 8 is a diagram illustrating an appearance in which an artificial intelligence model is trained through training data, an appearance in which the artificial intelligence model is verified through verification data, and an appearance in which a preprocessing engine is transmitted to a worker terminal in chronological order, according to the automated training based data labeling method according to the second embodiment of the present disclosure.

### DETAILED DESCRIPTION

Hereinafter, an automated training-based data labeling method according to the present disclosure will be described in detail with reference to the attached drawings. The accompanying drawings are provided by way of example in order to sufficiently transfer the spirit of the present disclosure to those skilled in the art, and the present disclosure is not limited to the accompanying drawing provided below, but may be implemented in another form.

In this specification, unless otherwise specified, “including” any component means that other components may be further included rather than excluding other components.

In addition, in this specification, “source data” refers to data in an unprocessed state (i.e., raw data) for which data labeling is to be performed by a worker, and “labeled data” refers to data on which the data labeling has been performed on objects in the source data.

In addition, in the present disclosure, an “artificial neural network” refers to basic architecture of an artificial intelligence model, and examples of the artificial neural network may include Faster Region based Convolutional Neural Networks (Faster R-CNN), Mask R-CNN, a SingleShot Detector (SSD), and You Only Look Once (YOLO), etc. In the present disclosure, the “artificial intelligence model” refers to a model generated as the artificial neural network is trained by the labeled data and a model that automatically performs the data labeling on the objects in the source data to a certain degree.

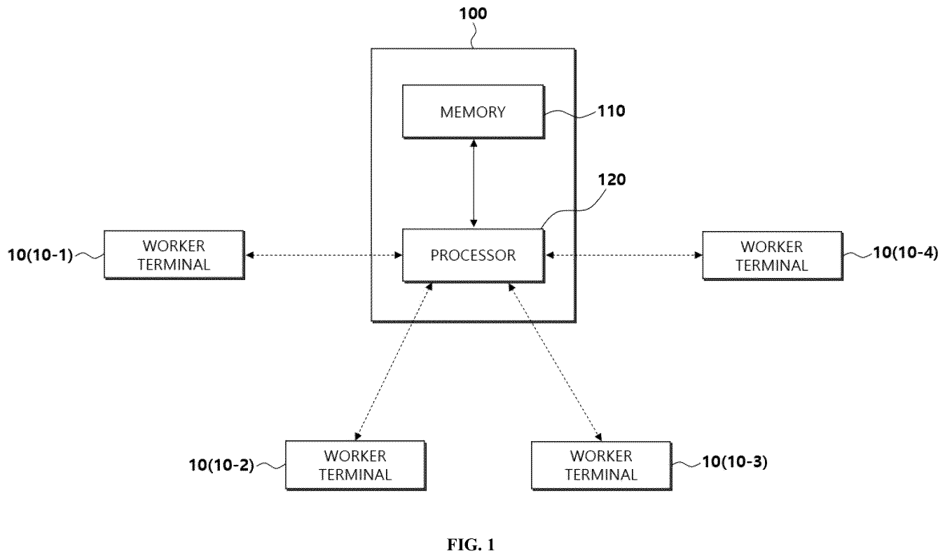

FIG. 1 is a diagram illustrating a device 100 for performing an automated training-based data labeling method according to the present disclosure together with a worker terminal 10. As illustrated in FIG. 1, the device 100 for performing the automated training-based data labeling method according to the present disclosure may include a memory 110 and a processor 120.

One or more instructions related to the automated training-based data labeling method according to the present disclosure are stored in the memory 110. In addition, the memory 110 may store an artificial neural network, a prior artificial intelligence model, and source data, etc. to perform the method. In addition, initial training data amount, a training cycle, a verification data set ratio, minimum required performance, termination condition, and hyperparameters (including training rate, epoch, etc.), etc. may be preset in the memory 110 to perform the method. To this end, the memory 110 may include a volatile or nonvolatile recording medium. For example, the memory 110 may be implemented by read only memory (ROM), random access memory (RAM), erasable programmable read only memory (EPROM), electrically erasable programmable read-only memory (EEPROM), flash memory, and static RAM (SRAM), hard disk drive (HDD), solid state drive (SSD), etc., or may be implemented including them.

The processor 120 performs the automated training-based data labeling method according to the present disclosure by executing one or more instructions stored in the memory 110. The instructions executed by the processor 120 are computer executable instructions. The processor 120 may be implemented by a micro processing unit (MPU), a central processing unit (CPU), a graphics processing unit (GPU), a tensor processing unit (TPU), etc., to execute the instructions, or implemented including them.

In the present disclosure, the worker terminal 10 (10-1, 10-2, 10-3, and 10-4) may be a computer or a smart terminal, etc., owned by a worker. The worker may communicate with the automated training-based data labeling device 100 through the worker terminal 10 (10-1, 10-2, 10-3, and 10-4) owned by the worker to receive source data from the device 100, perform data labeling on objects in the source data, and transmit labeled data on which the data labeling has been performed to the device 100. Here, the data labeling refers to a process of inputting correct data to the source data in a form that artificial intelligence may train.

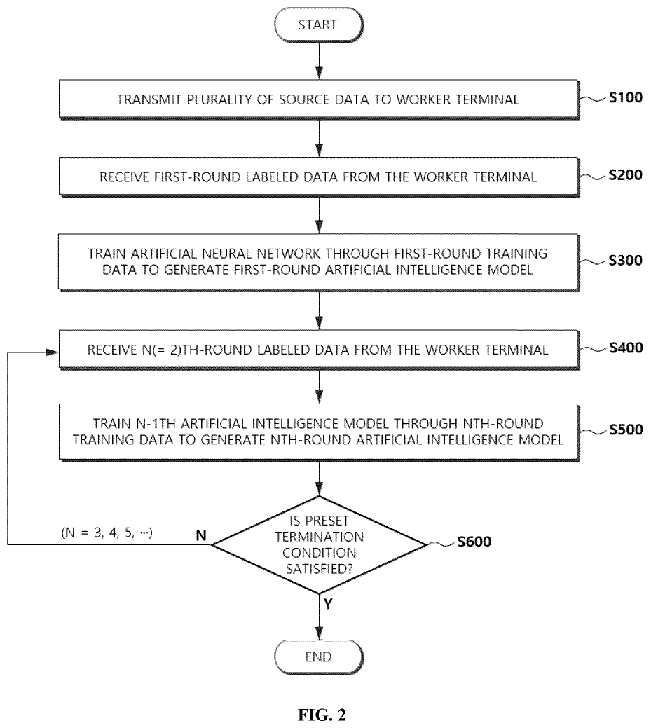

FIG. 2 is a flowchart of an automated training-based data labeling method according to a first embodiment of the present disclosure.

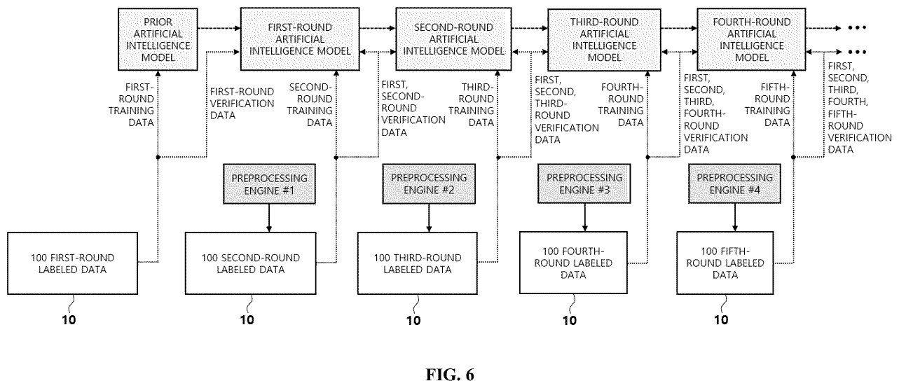

The automated training-based data labeling method according to the first embodiment of the present disclosure may include a step of first transmitting, by the processor 120, a plurality of source data to one or more worker terminals 10 (S100). Additional features of the automated training-based data labeling method according to the first embodiment of the present disclosure illustrated in FIG. 2 will be described further in conjunction with FIG. 6.

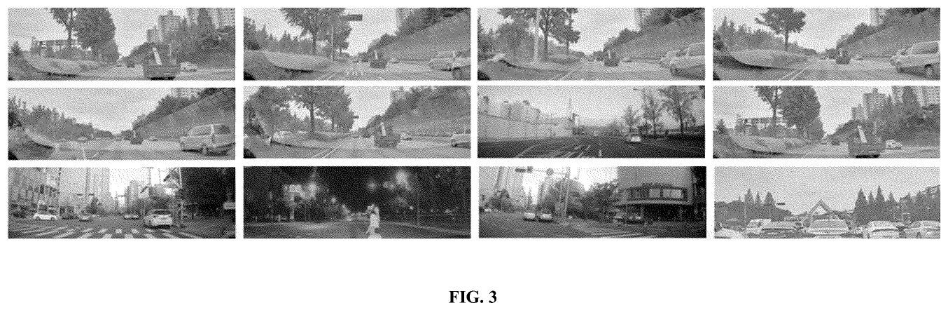

FIG. 3 is a diagram illustrating the source data transmitted to the worker terminal 10. The processor 120 may select the source data on which the data labeling should be performed by the worker terminal 10 among numerous source data stored in the memory 110, and transmit the selected source data to the worker terminal 10. In FIG. 3, although the source data is shown as image data, the source data may be other than image data, such as video data, text data, or audio data.

The initial training data amount preset in the memory 110 refers to the amount (i.e., the amount of first-round labeled data) of labeled data to be first trained through the artificial neural network. The training cycle preset in the memory 110 refers to the amount (i.e., the amount of nth-round labeled data) of labeled data to be trained through the artificial intelligence model. Hereinafter, the description will be made under the assumption that the initial training data amount is 1,000 and the training cycle is 100.

The n is a natural number applied in ascending order from 2 based on the number of times steps S400 to S500, which will be described later, are performed. That is, when the number of times steps S400 to S500 are performed is once, n is 2, when the number of times steps S400 to S500 are performed is two times, n is 3, and when the number of times steps S400 to S500 are performed is three times, n is 4.

The processor 120 may determine 1,000 source data (that is, initial training data) on which the data labeling should be performed by the worker terminal 10 among the source data stored in the memory 110 into the first-round source data, and transmit the determined source data to the worker terminal 10. When the number of worker terminals 10-1, 10-2, 10-3, and 10-4 is 4, the processor 120 may transmit 250 source data to each of the worker terminals 10-1, 10-2, 10-3, and 10-4 as the first-round source data.

In addition, the processor 120 may divide source data other than the first-round source data among the source data stored in the memory 110 into the nth-round source data, and transmit 100 different source data for each round to the worker terminal 10. That is, the processor 120 may select 100 source data among the source data stored in the memory 110 so as not to overlap with the first-round source data, and divide the selected 100 source data into second-round source data and transmit the divided 100 source data to the worker terminal 10. In addition, the processor 120 may select 100 source data among the source data stored in the memory 110 so as not to overlap with the first-round and second-round source data, and divide the selected 100 source data into third-round source data and transmit the divided 100 source data to the worker terminal 10.

In this way, the processor 120 may transmit the nth-round source data to the worker terminal 10. In this case, the processor 120 may transmit 25 source data to each of the worker terminals 10-1, 10-2, 10-3, and 10-4 as the nth-round source data.

Before transmitting the source data to the worker terminal 10, the processor 120 may determine a similarity among the source data to be transmitted to the worker terminal 10 according to similarity determination criteria preset in the processor 120. Here, the similarity among the source data may be determined based on at least one of a time when the source data is acquired, a location where the source data is acquired, the number of objects in the source data, a type of objects in the source data, and a degree of density of objects in the source data.

More specifically, the processor 120 may select the source data on which the data labeling should be performed by the worker terminal 10, and then determine that, among the selected source data, source data with the same acquisition time has a high similarity or source data with the same acquisition location has a high similarity.

Alternatively, the processor 120 may determine that, among the selected source data, source data with the same number of objects included in the source data has a high similarity.

Alternatively, the processor 120 may determine that, among the selected source data, source data with the same type (e.g., cars, insects, persons, etc.) of objects included in the source data has a high similarity. For example, when the source data is medical data, the processor 120 may determine that source data with the same type of disease included in the medical data has a high similarity.

Alternatively, the processor 120 may determine the similarity of the source data among the selected source data according to the degree of density of objects included in the source data. For example, when the source data is 3D LiDAR sensor data, the processor 120 may determine that the greater the degree of density of a point cloud included in the 3D LiDAR sensor data, the higher the similarity of the 3D LiDAR sensor data.

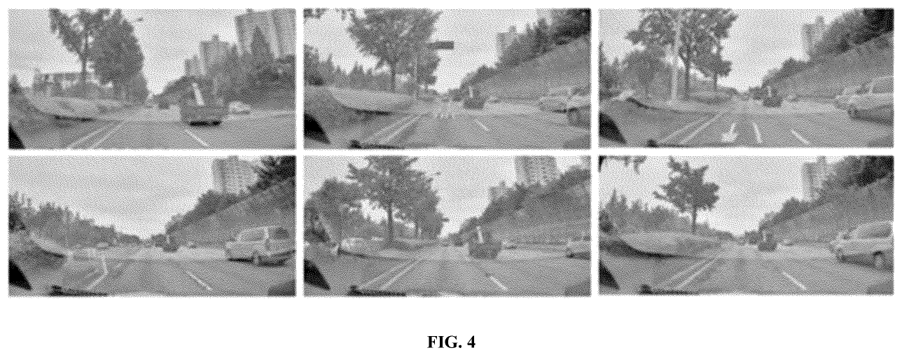

FIG. 4 is a diagram illustrating source data with relatively low similarity included in the first-round source data transmitted to the worker terminal 10. FIG. 4 illustrates source data with different acquisition locations.

As described above, the processor 120 may use 1,000 source data as the first-round source data and transmit 250 first-round data to each worker terminal 10-1, 10-2, 10-3, and 10-4. In this case, the first-round source data that the processor 120 transmits to each worker terminal 10-1, 10-2, 10-3, and 10-4 may include source data that has relatively low similarity to each other, as illustrated in FIG. 4.

The reason why the processor 120 includes the source data with low similarity to each other in the first-round source data is to allow the artificial neural network to train as many different environments as possible. By doing so, it is possible to improve the accuracy of the automated data labeling performed by the artificial intelligence model to be described later.

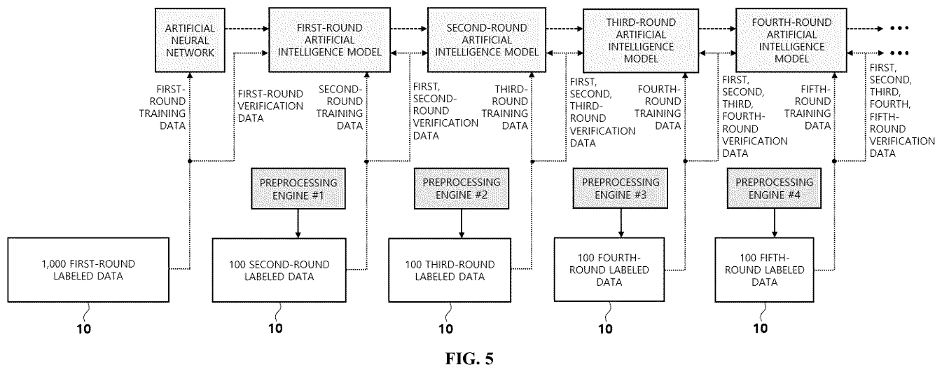

In contrast to FIG. 4, FIG. 5 is a diagram illustrating source data with relatively high similarity included in the nth-round source data transmitted to the worker terminal 10. FIG. 5 illustrates the source data with the same acquisition location.

As described above, the processor 120 may use 100 source data as the nth-round source data and transmit 25 nth-round data to each worker terminal 10-1, 10-2, 10-3, and 10-4. In this case, the nth-round source data that the processor 120 transmits to each worker terminal 10-1, 10-2, 10-3, and 10-4 may include source data that has relatively high similarity to each other, as illustrated in FIG. 5.

That is, the processor 120 may transmit a plurality of source data to the worker terminal 10 by dividing the plurality of source data into rounds according to the similarity among the source data. In this case, the processor 120 may include source data with low similarity to each other in the first-round source data transmitted to the worker terminal 10, and include source data with higher similarity than the similarity among the source data included in the first-round source data in the nth-round source data transmitted to the worker terminal 10.

More specifically, the nth-round source data that the processor 120 transmits to the worker terminal 10-1 may include the source data with higher similarity than the similarity among the source data included in the first-round source data. For example, the first-round source data that the processor 120 transmits to the worker terminal 10-1 may include only the source data with different acquisition locations as illustrated in FIG. 4, and the nth-round source data that the processor 120 transmits to the worker terminal 10-1 may include only the source data with the same acquisition location as illustrated in FIG. 5.

The nth-round source data that the processor 120 transmits to the worker terminal 10-2 may also include the source data with higher similarity than the similarity among the source data included in the first-round source data. For example, the first-round source data that the processor 120 transmits to the worker terminal 10-2 may include only the source data with different acquisition time, and the nth-round source data that the processor 120 transmits to the worker terminal 10-2 may include only the source data with the same acquisition time.

The reason why the processor 120 includes the source data with relatively high similarity to each other in the nth-round source data transmitted to the worker terminal 10 is to improve data labeling efficiency of a worker by allowing the worker to perform the data labeling with the source data with high similarity from the nth-round, thereby allowing projects related to the data labeling to be completed quickly.

Meanwhile, the first-round source data that the processor 120 transmits to the worker terminal 10 is data utilized by the artificial neural network to train as many diverse environments as possible. Accordingly, it is preferable that the number (e.g., 1,000) of source data included in the first-round source data that the processor 120 transmits to the worker terminal 10 is relatively large.

On the other hand, the nth-round source data that the processor 120 transmits to the worker terminal 10 is applied to the artificial intelligence model trained by the n−1th-round source data and is data utilized to update the artificial intelligence model. Therefore, the number (e.g., 250) of source data included in the nth-round source data that the processor 120 transmits to the worker terminal 10 may be smaller than the number (e.g., 1,000) of source data included in first-round source data that the processor 120 transmits to the worker terminal 10.

When the number of source data included in the nth-round source data that the processor 120 transmits to the worker terminal 10 is smaller than the number of source data included in the first-round source data, compared to the opposite case, a generation pace of the artificial intelligence model and the preprocessing model becomes faster. If the preprocessing model generated at such a fast pace is transmitted to the worker terminal 10, when the worker terminal 10 performs the data labeling, the preprocessing model may perform the automated data labeling relatively quickly and accurately. Therefore, it is preferable that the number (e.g., 250) of source data included in the nth-round source data that the processor 120 transmits to the worker terminal 10 is smaller than the number (e.g., 1,000) of source data included in first-round source data that the processor 120 transmits to the worker terminal 10.

A worker may sequentially perform the data labeling starting from first-round source data through the worker terminal 10. That is, the worker performs data labeling on objects in the first-round source data through the worker terminal 10 and transmits the labeled data on which the data labeling is performed to the automated training-based data labeling device 100. Thereafter, the worker performs data labeling on objects in the nth-round source data through the worker terminal 10 and transmits the labeled data on which the data labeling is performed to the automated training-based data labeling device 100.

However, although the example in which the processor 120 transmits a plurality of source data to one or more worker terminals 10 by dividing the plurality of source data into rounds has been described above, the processor 120 may transmit the plurality of source data to one or more worker terminals 10 without dividing the rounds. In this case, when the processor 120 receives the number (e.g., 1,000 labeled data that the processor 120 initially receives) of labeled data corresponding to the initial training data from the worker terminal 10, the labeled data may be utilized to train the artificial neural network by being used as the first-round labeled data. Thereafter, when the processor 120 receives the number (e.g., 100 labeled data each) of labeled data corresponding to the training cycle from the worker terminal 10, the labeled data may be utilized to train the artificial intelligence model by being used as n (=2, 3, 4, . . . ) th-round labeled data.

FIG. 6 is a diagram illustrating an appearance in which an artificial neural network and an artificial intelligence model are trained through training data, an appearance in which the artificial intelligence model is verified through verification data, and an appearance in which a preprocessing engine is transmitted to a worker terminal in chronological order, according to the automated training-based data labeling method according to the first embodiment of the present disclosure. Hereinafter, the automated training-based data labeling method according to the first embodiment of the present disclosure illustrated in FIG. 2 will be described in conjunction with reference to FIG. 6.

After step S100, the processor 120 receives, from the worker terminal 10, the first-round labeled data for which the data labeling is performed on the objects in the first-round source data among the plurality of source data (S200). According to the above example, the processor 120 may receive a total of 1,000 first-round labeled data from the worker terminal 10 (see ‘1,000 first-round labeled data’ in FIG. 6).

A verification data set ratio stored in the memory 110 refers to a ratio of verification data utilized to verify the performance of the artificial intelligence model in the labeled data for each round received by the processor 120. Thereafter, it will be described under the assumption that the verification data set ratio is 20% and the remaining 80% is the training data set ratio.

After step S200, the processor 120 generates a first-round artificial intelligence model that automatically performs the data labeling on the objects in the source data by separating some of the first-round labeled data into first-round training data and training the artificial neural network through the first-round training data (S300).

Specifically, the processor 120 may separate 800 of a total of 1,000 first-round labeled data into the first-round training data, and separate the remaining 200 of the first-round labeled data as first-round verification data. In this case, the processor 120 may randomly select and separate the training data and verification data among the first-round labeled data.

Thereafter, the processor 120 may generate the first-round artificial intelligence model that automatically performs the data labeling on the objects in the source data by loading the artificial neural network stored in the memory 110 and training the artificial neural network through 800 first-round training data (see the ‘artificial neural network’ and ‘first-round artificial intelligence model’ in FIG. 6). Here, the artificial neural network trained through the first-round training data may be Faster R-CNN, Mask R-CNN, SingleShot Detector (SSD) or YOLO, etc., and the processor 120 may store the generated first-round artificial intelligence model in the memory 110.

The processor 120 that generates the first-round artificial intelligence model may calculate the performance of the first-round artificial intelligence model utilizing 200 first-round verification data. Specifically, the processor 120 may calculate the performance of the first-round artificial intelligence model by inputting 200 source data (i.e., source data for which the data labeling is not performed on the first-round verification data) of the first-round verification data to the first-round artificial intelligence model and comparing 200 data output by the first-round artificial intelligence model with 200 first-round verification data. Here, the performance of the artificial intelligence model may be calculated as an indicator indicating the accuracy of object detection, such as intersection over union (IoU) or average precision (AP). However, the performance of the artificial intelligence model may be calculated as an indicator indicating various attributes, such as the speed of the object detection.

The processor 120 may load the minimum required performance preset in the memory 110 to verify the performance of the first-round artificial intelligence model. Here, the minimum required performance refers to conditions used to verify the performance of the artificial intelligence model, and may be preset based on indicators of the IoU, the AP, etc., such as ‘IoU of 90 or more’, ‘AP of 95 or more and IoU of 90 or more’, or ‘AP of 95 or more or IoU of 90 or more’.

The processor 120 may determine whether the performance of the first-round artificial intelligence model satisfies the preset minimum required performance. For example, when the minimum required performance preset in the memory 110 is ‘IoU of 90 or more’, the processor 120 may determine whether the performance of the first-round artificial intelligence model corresponds to ‘IoU of 90 or more’. In this way, when the processor 120 verifies the performance of the first-round artificial intelligence model based on the preset minimum required performance, since it may be determined whether the preprocessing engine generated based on the first-round artificial intelligence model performs the automated data labeling with relatively high efficiency, it may contribute to improving the data labeling efficiency of the worker.

As a result of the determination by the processor 120, when the performance of the first-round artificial intelligence model satisfies the preset minimum required performance, the processor 120 may designate the first-round artificial intelligence model as the preprocessing engine (see ‘preprocessing engine #1’ in FIG. 6).

At the time when the first-round artificial intelligence model is designated as the preprocessing engine, a worker may perform the data labeling on the objects in the source data (e.g., second-round source data) through the worker terminal 10. Accordingly, the processor 120 may transmit the preprocessing engine #1 to the worker terminal 10 in order to allow the worker to utilize automated data labeling performed by the preprocessing engine #1 when the worker performs the data labeling with the worker terminal 10.

That is, the preprocessing engine #1 transmitted to the worker terminal 10 may automatically perform the data labeling on at least some of objects in 100 second-round source data, so the time and effort for a worker to perform data labeling on objects in the second-round source data may be reduced.

On the other hand, as a result of the determination by the processor 120, when the performance of the first-round artificial intelligence model does not satisfy the preset minimum required performance, the processor 120 may not designate the first-round artificial intelligence model as the preprocessing engine.

This is because when the performance of the first-round artificial intelligence model does not satisfy the preset minimum required performance, even if the first-round artificial intelligence model is utilized as the preprocessing engine, the accuracy of the data labeling preprocessed in the preprocessing engine is bound to be low. When the accuracy of the data labeling preprocessed by the preprocessing engine is low, a worker should perform the data labeling while modifying the preprocessed labeled data, which will consume more time than when the worker performs the data labeling without the preprocessing engine. Accordingly, when the performance of the first-round artificial intelligence model does not satisfy the preset minimum required performance, it is preferable that the processor 120 does not designate the first-round artificial intelligence model as the preprocessing engine.

Meanwhile, the processor 120 may receive, from the worker terminal 10, the nth-round labeled data for which the data labeling is performed on the objects in the nth-round source data among the plurality of source data (S400). Referring to FIG. 2, it is illustrated in which the processor 120 receives n (=2)th-round labeled data from the worker terminal 10 after generating the first-round artificial intelligence model, but of course, the processor 120 may receive n (=2)th-round labeled data from the worker terminal 10 before or during generating the first-round artificial intelligence model.

As described above, n is a natural number applied in ascending order from 2 based on the number of times of repetition of steps S400 to S500, and when the number of times of repetition of steps S400 to S500 are performed is 1, n is 2. Therefore, the processor 120 may receive second-round labeled data for which the data labeling has been performed on objects in 100 second-round source data from the worker terminal 10 (see ‘100 second-round labeled data in FIG. 6).

After step S400, the processor 120 may generate an nth-round artificial intelligence model that automatically performs the data labeling on the objects in the source data by separating some of the nth-round labeled data into the nth-round training data, and additionally training an n−1th-round artificial neural model through the nth-round training data (S500).

When n is 2, the processor 120 may separate 80 of a total of 100 second-round labeled data into second-round training data. Thereafter, the processor 120 may generate a second-round artificial intelligence model that automatically performs the data labeling on the objects in the source data (see the ‘first-round artificial intelligence model’ and ‘second-round artificial intelligence model’ in FIG. 6) by loading the first-round artificial intelligence model stored in the memory 110 and additionally training the first-round artificial intelligence model through 80 second-round training data. That is, the processor 120 may update the first-round artificial intelligence model utilizing 80 second-round training data, and store the generated second-round artificial intelligence model in the memory 110.

In addition, the processor 120 may separate the remainder of the nth-round labeled data into nth-round verification data.

When n is 2, the processor 120 may separate the remaining 20 of a total of 100 second-round labeled data into second-round verification data. The processor 120 may randomly select and separate the training data and verification data among the second-round labeled data.

When the processor 120 generates the nth-round artificial intelligence model, the performance of the first-round artificial intelligence model to the nth-round artificial intelligence model may each be calculated by utilizing all of the first-round verification data to the nth-round verification data. This is because it may not know which artificial intelligence model among the first-round artificial intelligence model to the nth-round artificial intelligence model shows the best performance based on the first-round verification data to the mth-round verification data. In addition, when verifying the artificial intelligence model, it is preferable to utilize all of the first-round verification data to the nth-round verification data in order to verify the performance of the artificial intelligence model with high accuracy.

When n is 2, the processor 120 may utilize a total of 220 verification data (i.e., 200 first-round verification data and 20 second-round verification data) to calculate the performance of the first-round artificial intelligence model and the second-round artificial intelligence model, respectively. Here, the performance of the artificial intelligence model may be calculated using indicators such as the IoU or AP, etc.

After calculating the performance of the first-round artificial intelligence model to the nth-round artificial intelligence model, respectively, the processor 120 may select the artificial intelligence model with highest performance among the first-round artificial intelligence model to the nth-round artificial intelligence model. Here, it means that the selected artificial intelligence model may perform automated data labeling more quickly and accurately than the artificial intelligence model that is not selected, which may improve the data labeling efficiency of the worker. When n is 2, the processor 120 may select an artificial intelligence model with higher performance among the first-round artificial intelligence model and the second-round artificial intelligence model.

The processor 120 may reload the minimum required performance preset in the memory 110 to verify the performance of the selected artificial intelligence model. Thereafter, the processor 120 may determine whether the performance of the selected artificial intelligence model satisfies the preset minimum required performance. For example, when the minimum required performance preset in the memory 110 is ‘IoU of 90 or more’, the processor 120 may determine whether the performance of the selected artificial intelligence model corresponds to ‘IoU of 90 or more’.

As a result of the determination by the processor 120, when the performance of the selected artificial intelligence model satisfies the preset minimum required performance, the processor 120 may designate the selected artificial intelligence model as the preprocessing engine (see ‘preprocessing engine #2’ in FIG. 6).

At the time when the selected artificial intelligence model is designated as the preprocessing engine, a worker may perform the data labeling on the objects in the source data (e.g., third-round source data) through the worker terminal 10. Accordingly, the processor 120 may transmit the preprocessing engine #2 to the worker terminal 10 in order to allow the worker to utilize automated data labeling performed by the preprocessing engine #2 when the worker performs the data labeling with the worker terminal 10.

That is, the preprocessing engine #2 transmitted to the worker terminal 10 may automatically perform the data labeling on at least some of objects in 100 third-round source data, so the time and effort for a worker to perform data labeling on objects in the third-round source data may be dramatically reduced. Here, the automated data labeling that the preprocessing engine #2 performs on the objects in the third-round source data may be faster and more accurate than the automated data labeling that the preprocessing engine #1 performs on the objects in the second-round source data.

On the other hand, as a result of the determination by the processor 120, when the performance of the selected artificial intelligence model does not satisfy the preset minimum required performance, the processor 120 may not designate the selected artificial intelligence model as the preprocessing engine.

This is because when the performance of the selected artificial intelligence model does not satisfy the preset minimum required performance, even if the selected artificial intelligence model is utilized as the preprocessing engine, the accuracy of the data labeling preprocessed in the preprocessing engine is bound to be low. When the accuracy of the data labeling preprocessed by the preprocessing engine is low, a worker should perform the data labeling while modifying the preprocessed labeled data, which will consume more time than when the worker performs the data labeling without the preprocessing engine. Accordingly, when the performance of the selected artificial intelligence model does not satisfy the preset minimum required performance, it is preferable that the processor 120 does not designate the selected artificial intelligence model as the preprocessing engine.

After step S500, the processor 120 determines whether the automated training-based data labeling method satisfies the termination conditions preset in the memory 110, and may repeatedly perform step S400 to step S500 until the preset termination conditions are satisfied (S600).

For example, the preset termination conditions may correspond to receiving last-round labeled data of the source data that the processor 120 transmits to the worker terminal 10, and to whether the artificial intelligence model is trained through the training data of the labeled data for the last round. Alternatively, the preset termination conditions may correspond to whether the performance of the nth-round artificial intelligence model generated in step S500 exceeds specific required performance preset in the memory 110. However, the preset termination condition is not limited thereto, and various other termination conditions may be preset in the memory 110.

As a result of the determination by the processor 120, when the automated training-based data labeling method satisfies the preset termination conditions, the processor 120 may terminate the procedure.

On the other hand, as a result of the determination by the processor 120, when the automated training-based data labeling method does not satisfy the preset termination conditions, the processor 120 may repeatedly perform steps S400 to S500.

When the processor 120 performs steps S400 to S500 again, the processor 120 may receive, from the worker terminal 10, third-round labeled data for which the data labeling is performed on objects in the third-round source data among the plurality of source data (see ‘100 third-round labeled data’ in FIG. 6). Referring to FIG. 2, it is illustrated that the processor 120 receives n (=3) th-round labeled data from the worker terminal 10 after generating the n (=2)th-round artificial intelligence model, but of course, the processor 120 may receive the third-round labeled data from the worker terminal 10 before or during generating the second-round artificial intelligence model.

Thereafter, the processor 120 may separate 80 of a total of 100 third-round labeled data into the third-round training data and load the second-round artificial intelligence model stored in the memory 110. The processor 120 may generate the third-round artificial intelligence model that automatically performs the data labeling on the objects in the source data by additionally training the second-round artificial intelligence model through 80 third-round training data (see ‘the second-round artificial intelligence model’ and ‘the third-round artificial intelligence model’ in FIG. 6). That is, the processor 120 may update the second-round artificial intelligence model utilizing 80 third-round training data, and store the generated third-round artificial intelligence model in the memory 110.

In addition, the processor 120 may separate the remaining 20 of a total of 100 third-round labeled data into the third-round verification data. The processor 120 may randomly select and separate the training data and verification data among the third-round labeled data.

When the processor 120 generates the third-round artificial intelligence model, the performance of the first-round artificial intelligence model to the third-round artificial intelligence model may each be calculated by utilizing all of the first-round verification data to the third-round verification data. That is, the processor 120 may utilize a total of 240 verification data (i.e., 200 first-round verification data, 20 second-round verification data, and 20 third-round verification data), thereby calculating the performance of the first-round artificial intelligence model, the second-round artificial intelligence model, and the third-round artificial intelligence model, respectively. Here, the performance of the artificial intelligence model may be calculated using indicators such as the IoU or AP, etc.

After calculating the performance of the first-round artificial intelligence model to the third-round artificial intelligence model, respectively, the processor 120 may select the artificial intelligence model with highest performance among the first-round artificial intelligence model to the third-round artificial intelligence model.

When the artificial intelligence model selected by the processor 120 is, for example, the third-round artificial intelligence model, the processor 120 may reload the minimum required performance preset in the memory 110 to verify the performance of the selected third-round artificial intelligence model and determine whether the performance of the selected third-round artificial intelligence model satisfies the preset minimum required performance. For example, when the minimum required performance preset in the memory 110 is ‘IoU of 90 or more’, the processor 120 may determine whether the performance of the selected third-round artificial intelligence model corresponds to ‘IoU of 90 or more’.

As a result of the determination by the processor 120, when the performance of the selected third-round artificial intelligence model satisfies the preset minimum required performance, the processor 120 may designate the selected third-round artificial intelligence model as the preprocessing engine (see ‘preprocessing engine #3’ in FIG. 6).

At the time when the selected third-round artificial intelligence model is designated as the preprocessing engine, a worker may perform the data labeling on the objects in the source data (e.g., fourth-round source data) through the worker terminal 10. Accordingly, the processor 120 may transmit the preprocessing engine #3 to the worker terminal 10 in order to allow the worker to utilize automated data labeling performed by the preprocessing engine #3 when the worker performs the data labeling with the worker terminal 10.

That is, the preprocessing engine #3 transmitted to the worker terminal 10 may automatically perform the data labeling on at least some of objects in 100 fourth-round source data, so the time and effort for a worker to perform data labeling on the objects in the fourth-round source data may be dramatically reduced. Here, the automated data labeling that the preprocessing engine #3 performs on the objects in the fourth-round source data may be faster and more accurate than the automated data labeling that the preprocessing engine #2 performs on the objects in the third-round source data.

On the other hand, as a result of the determination by the processor 120, when the performance of the selected third-round artificial intelligence model does not satisfy the preset minimum required performance, the processor 120 may not designate the selected third-round artificial intelligence model as the preprocessing engine. As described above, this is because when the performance of the selected third-round artificial intelligence model does not satisfy the preset minimum required performance, even if the selected third-round artificial intelligence model is utilized as the preprocessing engine, the accuracy of the data labeling preprocessed in the preprocessing engine is bound to be low.

Thereafter, the processor 120 determines again whether the automated training-based data labeling method satisfies the termination conditions preset in the memory 110.

As a result of the determination by the processor 120, when the automated training-based data labeling method satisfies the preset termination conditions, the processor 120 may terminate the procedure. On the other hand, when the automated training-based data labeling method does not satisfy the preset termination conditions, the processor 120 may perform steps S400 to S500 again.

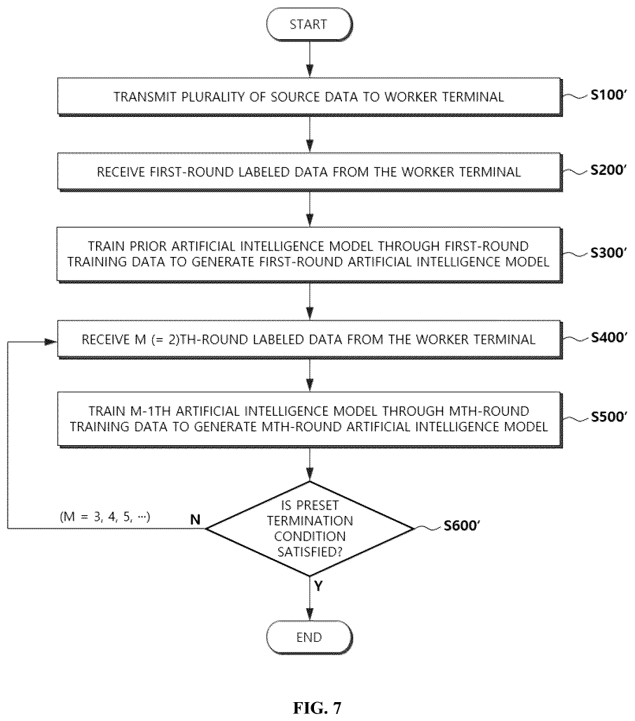

Meanwhile, FIG. 7 is a flowchart of an automated training-based data labeling method according to a second embodiment of the present disclosure. The second embodiment of the present disclosure is different from the first embodiment of the present disclosure in that it trains a prior artificial intelligence model instead of the artificial neural network through the first-round training data. Here, the prior artificial intelligence model is a model generated as the artificial neural network is trained by labeled data, and refers to an artificial intelligence model that has been pre-trained by the labeled data to automatically perform the data labeling on the objects in the source data. For example, a prior artificial intelligence model may refer to an artificial intelligence model in which the artificial neural networks such as Faster R-CNN, Mask R-CNN, SingleShot Detector (SSD), or YOLO have been pre-trained by labeled data.

The second embodiment of the present disclosure relates to an automated training-based data labeling method performed when such a prior artificial intelligence model has already been built. Unless it directly contradicts the previous description, the matters described above regarding the first embodiment may be equally applied to the second embodiment.

The automated training-based data labeling method according to the second embodiment of the present disclosure may include a step of first transmitting, by the processor 120, a plurality of source data to one or more worker terminals 10 (S100).

As described above with reference to FIG. 3, the processor 120 may select the source data on which the data labeling should be performed by the worker terminal 10 among numerous source data stored in the memory 110, and transmit the selected source data to the worker terminal 10. In this case, the processor 120 may transmit the plurality of source data to one or more worker terminals 10 by dividing the rounds.

When the processor 120 transmits the plurality of source data to one or more worker terminals 10 by dividing the rounds, the processor 120 may transmit, to the worker terminal 10, 100 source data for which the data labeling should be performed by the worker terminal 10 among the source data stored in the memory 110 by dividing the 100 source data into the first-round source data. When the number of worker terminals 10-1, 10-2, 10-3, and 10-4 is 4, the processor 120 may transmit 25 source data to each of the worker terminals 10-1, 10-2, 10-3, and 10-4 as the first-round source data. In the first embodiment of the present disclosure, a relatively large number of labeled data was required to train the artificial neural network, but in the second embodiment of the present disclosure, since the prior artificial intelligence model has already been built, it is possible to train and update the prior artificial intelligence model only with less labeled data than the amount of labeled data required to train the artificial neural network.

In addition, the processor 120 may divide source data other than the first-round source data among the source data stored in the memory 110 into the mth-round source data, and transmit 100 different source data for each round to the worker terminal 10. That is, the processor 120 may select 100 source data among the source data stored in the memory 110 so as not to overlap with the first-round source data, and divide the selected 100 source data into second-round source data and transmit the divided 100 source data to the worker terminal 10. In addition, the processor 120 may select 100 source data among the source data stored in the memory 110 so as not to overlap with the first-round and second-round source data, and divide the selected 100 source data into third-round source data and transmit the divided 100 source data to the worker terminal 10.

In this way, the processor 120 may transmit the mth-round source data to the worker terminal 10. The m is a natural number applied in ascending order from 2 based on the number of times steps S400′ to S500′, which will be described later, are performed. That is, when the number of times steps S400′ to S500′ are performed is once, m is 2, when the number of times steps S400′ to S500′ are performed is two times, m is 3, and when the number of times steps S400′ to S500′ are performed is three times, m is 4. The processor 120 may transmit 25 source data to each of the worker terminals 10-1, 10-2, 10-3, and 10-4 as the mth-round source data.

Before transmitting the source data to the worker terminal 10, the processor 120 may determine a similarity among the source data to be transmitted to the worker terminal 10 according to similarity determination criteria preset in the processor 120. Here, the similarity among the source data may be determined based on at least one of a time when the source data is acquired, a location where the source data is acquired, the number of objects in the source data, a type of objects in the source data, and a degree of density of objects in the source data. A specific example in which the processor 120 determines the similarity among source data is the same as described in the first embodiment of the present disclosure.

The processor 120 may transmit the plurality of source data to one or more worker terminals 10 by dividing the plurality of source data into rounds according to the similarity among the source data.

In this case, the processor 120 may include the source data with relatively high similarity in the first-round source data (or mth-round source data) transmitted to each of the worker terminals 10-1, 10-2, 10-3, and 10-4. For example, the similarity among 25 source data included in the first-round source data (or mth-round source data) that the processor 120 transmits to the worker terminal 10-1 may be relatively high, and the similarity among 25 source data included in the first-round source data (or mth-round source data) that the processor 120 transmits to the worker terminal 10-2 may be relatively high. However, the similarity among the source data included in the first-round source data (or mth-round source data) that the processor 120 transmits to one worker terminal 10-1 and the source data included in the first-round source data (or mth-round source data) that the processor 120 transmits to another worker terminal 10-2 may be high or low.

The reason of including the source data with high similarity to each other in the first-round source data (or mth-round source data) that the processor 120 transmits to each of the worker terminals 10-1, 10-2, 10-3, and 10-4 is to improve the data labeling efficiency of the worker by performing the data labeling with the source data with high similarities for each worker, thereby allowing projects related to the data labeling to be completed quickly.

Although the example in which the processor 120 transmits a plurality of source data to one or more worker terminals 10 by dividing the plurality of source data into rounds has been described above, the processor 120 may transmit the plurality of source data to one or more worker terminals 10 without dividing the rounds. In this case, when the processor 120 receives the number (e.g., 100 labeled data each) of labeled data corresponding to the training cycle from one or more worker terminals 10, the labeled data may be utilized to train the artificial intelligence model by being used as the first-round labeled data and m (=2, 3, 4, . . . ) th-round labeled data.

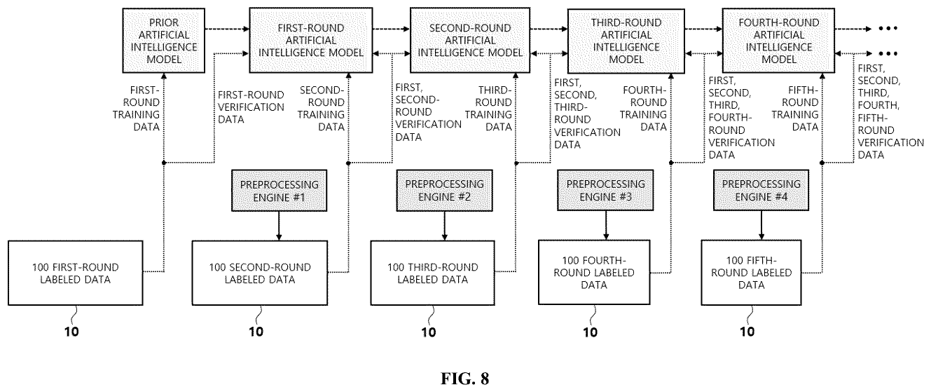

FIG. 8 is a diagram illustrating an appearance in which an artificial intelligence model is trained through training data, an appearance in which the artificial intelligence model is verified through verification data, and an appearance in which a preprocessing engine is transmitted to a worker terminal in chronological order, according to the automated training-based data labeling method according to the second embodiment of the present disclosure. Hereinafter, the automated training-based the data labeling method according to the second embodiment of the present disclosure will be described with further reference to FIG. 8.

After step S100′, the processor 120 receives, from the worker terminal 10, the first-round labeled data for which the data labeling is performed on the objects in the first-round source data among the plurality of source data (S200′). According to the above example, the processor 120 may receive a total of 100 first-round labeled data from the worker terminal 10 (see ‘100 first-round labeled data’ in FIG. 8).

After step S200′, the processor 120 generates the first-round artificial intelligence model that automatically performs the data labeling on the objects in the source data by separating some of the first-round labeled data into the first-round training data and additionally training the prior artificial intelligence model that is pre-trained to automatically perform the data labeling on the objects in the source data through the first-round training data (S300′).

Specifically, the processor 120 may separate 80 of a total of 100 first-round labeled data into the first-round training data, and separate the remaining 20 of the first-round labeled data as first-round verification data. In this case, the processor 120 may randomly select and separate the training data and verification data among the first-round labeled data.

Thereafter, the processor 120 may generate the first-round artificial intelligence model that automatically performs the data labeling on the objects in the source data by loading the prior artificial intelligence model stored in the memory 110 and additionally training the prior artificial intelligence model through 80 first-round training data (see the ‘prior artificial intelligence model’ and ‘first-round artificial intelligence model’ in FIG. 8). That is, the processor 120 may update the prior artificial intelligence model utilizing 80 first-round training data, and store the generated first-round artificial intelligence model in the memory 110.

The processor 120 that generates the first-round artificial intelligence model may calculate the performance of the prior artificial intelligence model and the first-round artificial intelligence model, respectively, utilizing 20 first-round verification data. Specifically, the processor 120 may calculate the performance of the prior artificial intelligence model and the first-round artificial intelligence model, respectively, by inputting 20 source data (i.e., source data for which the data labeling is not performed on the first-round verification data) of the first-round verification data to the prior artificial intelligence model and the first-round artificial intelligence model, respectively, and comparing 20 data output by the prior artificial intelligence model and the first-round artificial intelligence model, respectively, with 20 first-round verification data. Here, the performance of the artificial intelligence model may be calculated using indicators such as the IoU or AP, etc.

The processor 120 may select the artificial intelligence model with higher performance among the prior artificial intelligence model and the first-round artificial intelligence model. Here, it means that the selected artificial intelligence model may perform automated data labeling more quickly and accurately than the artificial intelligence model that is not selected, which may improve the data labeling efficiency of the worker.

The processor 120 may load the minimum required performance preset in the memory 110 to verify the performance of the selected artificial intelligence model. Thereafter, the processor 120 may determine whether the performance of the selected artificial intelligence model satisfies the preset minimum required performance. For example, when the minimum required performance stored in the memory 110 is ‘IoU of 90 or more’, the processor 120 may determine whether the performance of the selected artificial intelligence model corresponds to ‘IoU of 90 or more’.

As a result of the determination by the processor 120, when the performance of the selected artificial intelligence model satisfies the preset minimum required performance, the processor 120 may designate the selected artificial intelligence model as the preprocessing engine (see ‘preprocessing engine #l’ in FIG. 8).

At the time when the selected artificial intelligence model is designated as the preprocessing engine, a worker may perform the data labeling on the objects in the source data (e.g., second-round source data) through the worker terminal 10. Accordingly, the processor 120 may transmit the preprocessing engine #1 to the worker terminal 10 in order to allow the worker to utilize automated data labeling performed by the preprocessing engine #1 when the worker performs the data labeling with the worker terminal 10.

That is, the preprocessing engine #1 transmitted to the worker terminal 10 may automatically perform the data labeling on at least some of objects in 100 second-round source data, so the time and effort for a worker to perform data labeling on objects in the second-round source data may be reduced. When the first-round artificial intelligence model is selected as the preprocessing engine #1, the automated data labeling performed by the first-round artificial intelligence model on the objects in the second-round source data may be faster and more accurate than the automated data labeling performed by the prior artificial intelligence models on the objects in the second-round source data.

On the other hand, as a result of the determination by the processor 120, when the performance of the selected artificial intelligence model does not satisfy the preset minimum required performance, the processor 120 may not designate the selected artificial intelligence model as the preprocessing engine. This is because when the performance of the selected artificial intelligence model does not satisfy the preset minimum required performance, even if the selected artificial intelligence model is utilized as the preprocessing engine, the accuracy of the data labeling preprocessed in the preprocessing engine is bound to be low.

Meanwhile, in order to update the first-round artificial intelligence model generated in step S300′, the processor 120 may receive, from the worker terminal 10, mth-round labeled data for which the data labeling is performed on the objects in the mth-round source data among the plurality of source data (S400′). Referring to FIG. 7, it is illustrated in which the processor 120 receives m (=2)th-round labeled data from the worker terminal 10 after generating the first-round artificial intelligence model, but of course, the processor 120 may receive mth-round labeled data from the worker terminal 10 before or during generating the first-round artificial intelligence model.

As described above, m is a natural number applied in ascending order from 2 based on the number of times of repetition of steps S400′ to S500′, and when the number of times of repetition of steps S400′ to S500′ are performed is 1, m is 2. Therefore, the processor 120 may receive second-round labeled data for which the data labeling has been performed on objects in 100 second-round source data from the worker terminal 10 (see ‘100 second-round labeled data in FIG. 8).

After step S400’, the processor 120 may generate an mth-round artificial intelligence model that automatically performs the data labeling on the objects in the source data by separating some of the mth-round labeled data into the mth-round training data, and additionally training an m−1th-round artificial intelligence model through the mth-round training data (S500′).

When m is 2, the processor 120 may separate 80 of a total of 100 second-round labeled data into second-round training data. Thereafter, the processor 120 may generate a second-round artificial intelligence model that automatically performs the data labeling on the objects in the source data (see the ‘first-round artificial intelligence model’ and ‘second-round artificial intelligence model’ in FIG. 8) by loading the first-round artificial intelligence model stored in the memory 110 and additionally training the first-round artificial intelligence model through 80 second-round training data. That is, the processor 120 may update the first-round artificial intelligence model utilizing 80 second-round training data, and store the generated second-round artificial intelligence model in the memory 110.

In addition, the processor 120 may separate the remainder of the mth-round labeled data into mth-round verification data.

When m is 2, the processor 120 may separate the remaining 20 of a total of 100 second-round labeled data into second-round verification data. The processor 120 may randomly select and separate the training data and verification data among the second-round labeled data.

When the processor 120 generates the mth-round artificial intelligence model, the performance of ‘the prior artificial intelligence model and the first-round artificial intelligence model to the mth-round artificial intelligence model’ may each be calculated by utilizing all of the first-round verification data to the mth-round verification data. This is because it may not know which artificial intelligence model among ‘the prior artificial intelligence model and the first-round artificial intelligence model to the mth-round artificial intelligence model’ shows the best performance based on the first-round verification data to the mth-round verification data. In addition, when verifying the artificial intelligence model, it is preferable to utilize all of the first-round verification data to the mth-round verification data in order to verify the performance of the artificial intelligence model with high accuracy.

When m is 2, the processor 120 may utilize a total of 40 verification data (i.e., 20 first-round verification data and 20 second-round verification data) to calculate the performance of the prior artificial intelligence model and the first-round artificial intelligence model and the second-round artificial intelligence model, respectively. Here, the performance of the artificial intelligence model may be calculated using indicators such as the IoU or AP, etc.

After calculating the performance of the prior artificial intelligence model and the first-round artificial intelligence model to the mth-round artificial intelligence model, respectively, the processor 120 may select the artificial intelligence model with highest performance among the prior artificial intelligence model and the first-round artificial intelligence model to the mth-round artificial intelligence model. Here, the selected artificial intelligence model may perform automated data labeling more quickly and accurately than the artificial intelligence model that is not selected, so it is possible to improve the data labeling efficiency of the worker. When m is 2, the processor 120 may select an artificial intelligence model with highest performance among the prior artificial intelligence model and the first-round artificial intelligence model and the second-round artificial intelligence model.

The processor 120 may reload the minimum required performance preset in the memory 110 to verify the performance of the selected artificial intelligence model. Thereafter, the processor 120 may determine whether the performance of the selected artificial intelligence model satisfies the preset minimum required performance. For example, when the minimum required performance stored in the memory 110 is ‘IoU of 90 or more’, the processor 120 may determine whether the performance of the selected artificial intelligence model corresponds to ‘IoU of 90 or more’.

As a result of the determination by the processor 120, when the performance of the selected artificial intelligence model satisfies the preset minimum required performance, the processor 120 may designate the selected artificial intelligence model as the preprocessing engine (see ‘preprocessing engine #2’ in FIG. 8).

At the time when the selected artificial intelligence model is designated as the preprocessing engine, a worker may perform the data labeling on the objects in the source data (e.g., third-round source data) through the worker terminal 10. Accordingly, the processor 120 may transmit the preprocessing engine #2 to the worker terminal 10 in order to allow the worker to utilize automated data labeling performed by the preprocessing engine #2 when the worker performs the data labeling with the worker terminal 10.

That is, the preprocessing engine #2 transmitted to the worker terminal 10 may automatically perform the data labeling on at least some of objects in 100 third-round source data, so the time and effort for a worker to perform data labeling on objects in the third-round source data may be dramatically reduced. Here, the automated data labeling that the preprocessing engine #2 performs on the objects in the third-round source data may be faster and more accurate than the automated data labeling that the preprocessing engine #1 performs on the objects in the second-round source data.

On the other hand, as a result of the determination by the processor 120, when the performance of the selected artificial intelligence model does not satisfy the preset minimum required performance, the processor 120 may not designate the selected artificial intelligence model as the preprocessing engine. This is because when the performance of the selected artificial intelligence model does not satisfy the preset minimum required performance, even if the selected artificial intelligence model is utilized as the preprocessing engine, the accuracy of the data labeling preprocessed in the preprocessing engine is bound to be low.

After step S500′, the processor 120 determines whether the automated training-based data labeling method satisfies the termination conditions preset in the memory 110, and may repeatedly perform step S400′ to step S500′ until the preset termination conditions are satisfied (S600′).

As described above, the preset termination conditions may correspond to receiving last-round labeled data of the source data that the processor 120 transmits to the worker terminal 10, and to whether the artificial intelligence model is trained through the training data of the labeled data for the last round. Alternatively, the preset termination conditions may correspond to whether the performance of the nth-round artificial intelligence model generated in step S500 exceeds specific required performance preset in the memory 110. However, the preset termination condition is not limited thereto, and various other termination conditions may be preset in the memory 110.

As a result of the determination by the processor 120, when the automated training-based data labeling method satisfies the preset termination conditions, the processor 120 may terminate the procedure.

On the other hand, as a result of the determination by the processor 120, when the automated training-based data labeling method does not satisfy the preset termination conditions, the processor 120 may repeatedly perform steps S400′ to S500′.

When the processor 120 performs steps S400′ to S500′ again, the processor 120 may receive, from the worker terminal 10, third-round labeled data for which the data labeling is performed on objects in the third-round source data among the plurality of source data (see ‘100 third-round labeled data’ in FIG. 8). Referring to FIG. 7, it is illustrated that the processor 120 receives n (=3) th-round labeled data from the worker terminal 10 after generating the m (=2)th-round artificial intelligence model, but of course, the processor 120 may receive the third-round labeled data from the worker terminal 10 before or during generating the second-round artificial intelligence model.

Thereafter, the processor 120 may separate 80 of a total of 100 third-round labeled data into the third-round training data and load the second-round artificial intelligence model stored in the memory 110. The processor 120 may generate the third-round artificial intelligence model that automatically performs the data labeling on the objects in the source data by additionally training the second-round artificial intelligence model through 80 third-round training data (see ‘the second-round artificial intelligence model’ and ‘the third-round artificial intelligence model’ in FIG. 8). That is, the processor 120 may update the second-round artificial intelligence model utilizing 80 third-round training data, and store the generated third-round artificial intelligence model in the memory 110.

In addition, the processor 120 may separate the remaining 20 of a total of 100 third-round labeled data into the third-round verification data. The processor 120 may randomly select and separate the training data and verification data among the third-round labeled data.

When the processor 120 generates the third-round artificial intelligence model, the performance of the prior artificial intelligence model and the first-round artificial intelligence model to the third-round artificial intelligence model may each be calculated by utilizing all of the first-round verification data to the third-round verification data. That is, the processor 120 may utilize a total of 60 verification data (i.e., 200 first-round verification data, 20 second-round verification data, and 20 third-round verification data), thereby calculating the performance of the prior artificial intelligence model, the first-round artificial intelligence model, the second-round artificial intelligence model, and the third-round artificial intelligence model, respectively. Here, the performance of the artificial intelligence model may be calculated using indicators such as the IoU or AP, etc.

After calculating the performance of the prior artificial intelligence model and the first-round artificial intelligence model to the third-round artificial intelligence model, respectively, the processor 120 may select the artificial intelligence model with highest performance among the prior artificial intelligence model and the first-round artificial intelligence model to the third-round artificial intelligence model.

When the artificial intelligence model selected by the processor 120 is, for example, the third-round artificial intelligence model, the processor 120 may reload the minimum required performance preset in the memory 110 to verify the performance of the selected third-round artificial intelligence model and determine whether the performance of the selected third-round artificial intelligence model satisfies the preset minimum required performance. For example, when the minimum required performance preset in the memory 110 is ‘IoU of 90 or more’, the processor 120 may determine whether the performance of the selected third-round artificial intelligence model corresponds to ‘IoU of 90 or more’.

As a result of the determination by the processor 120, when the performance of the selected third-round artificial intelligence model satisfies the preset minimum required performance, the processor 120 may designate the selected third-round artificial intelligence model as the preprocessing engine (see ‘preprocessing engine #3’ in FIG. 8).

At the time when the selected third-round artificial intelligence model is designated as the preprocessing engine, a worker may perform the data labeling on the objects in the source data (e.g., fourth-round source data) through the worker terminal 10. Accordingly, the processor 120 may transmit the preprocessing engine #3 to the worker terminal 10 in order to allow the worker to utilize automated data labeling performed by the preprocessing engine #3 when the worker performs the data labeling with the worker terminal 10.

That is, the preprocessing engine #3 transmitted to the worker terminal 10 may automatically perform the data labeling on at least some of objects in 100 fourth-round source data, so the time and effort for a worker to perform data labeling on the objects in the fourth-round source data may be reduced. Here, the automated data labeling that the preprocessing engine #3 performs on the objects in the fourth-round source data may be faster and more accurate than the automated data labeling that the preprocessing engine #2 performs on the objects in the third-round source data.

On the other hand, as a result of the determination by the processor 120, when the performance of the selected third-round artificial intelligence model does not satisfy the preset minimum required performance, the processor 120 may not designate the selected third-round artificial intelligence model as the preprocessing engine. As described above, this is because when the performance of the selected third-round artificial intelligence model does not satisfy the preset minimum required performance, even if the selected third-round artificial intelligence model is utilized as the preprocessing engine, the accuracy of the data labeling preprocessed in the preprocessing engine is bound to be low.

Thereafter, the processor 120 determines again whether the automated training-based data labeling method satisfies the termination conditions preset in the memory 110.

As a result of the determination by the processor 120, when the automated training-based data labeling method satisfies the preset termination conditions, the processor 120 may terminate the procedure. On the other hand, when the automated training-based data labeling method does not satisfy the preset termination conditions, the processor 120 may perform steps S400′ to S500′ again.

Meanwhile, the automated training-based data labeling method according to the present disclosure described above may be implemented by computer executable instructions that may be executed through various computer means such as a processor and stored in a computer-readable storage medium. The computer-executable instructions stored in the storage medium may be specially designed and configured for the present disclosure.

Examples of the computer-readable storage medium may include read only memory (ROM), random access memory (RAM), erasable programmable read only memory (EPROM), electrically erasable programmable read-only memory (EEPROM), flash memory, static RAM (SRAM), a hard disk drive (HDD), and a solid state drive (SSD), or a volatile or non-volatile hardware device configured to store computer-executable instructions such as types well known in the art to which the present disclosure pertains.

Examples of the computer-executable instructions may include a code generated or executed by a compiler or interpreter. For example, the above-described automated training-based data labeling method may be performed by allowing the processor to execute the instructions stored in the storage medium. The storage medium may be provided in the form of a non-transitory storage medium. Here, the “non-transitory” means that the storage medium is tangible without including a signal, and does not distinguish whether data are semi-permanently or temporarily stored in the storage medium.

The disclosed technology is configured to generate the artificial intelligence model in which the processor separates some of the labeled data into the training data as soon as it receives a certain amount of labeled data from the worker terminal, and automatically performs the data labeling on the objects in the source data through the automated training of the training data. According to the present disclosure, since there is no need for the artificial intelligence developer to be involved when generating the artificial intelligence model, and the proportion of worker participation is reduced when labeling the data for the objects in the source data, it is possible to dramatically reduce the development costs of the artificial intelligence model and the operation costs required for the data labeling.

In addition, according to the present disclosure, as the number of labeled data that the processor receives from the worker terminal increases, it is possible to generate the preprocessing engine having higher accuracy. That is, as the number of labeled data that the processor receives from the worker terminal increases, the proportion of the preprocessing engine automatically performing the data labeling may increase and the accuracy of object detection may be improved, so it is possible to continuously improve the data labeling efficiency of the workers.

In addition, according to the present disclosure, as the processor performs the automated training-based on the labeled data belonging to a project, it is possible to generate the preprocessing engine with performance optimized for the project.

In addition, according to the present disclosure, since the artificial intelligence model and preprocessing engine are generated through the automated training of the labeled data without the intervention of the artificial intelligence developer, compared to the case where the artificial intelligence developer intervenes to generate the artificial intelligence model and preprocessing engine, the time at which the preprocessing engine is introduced into the worker terminal becomes faster, and the pace at which the preprocessing engine is improved to have better performance also becomes faster.

In addition, according to the present disclosure, when there are a plurality of new projects, the preprocessing engine for one of the projects is not generated before the preprocessing engine for other projects is generated, but the preprocessing engines suitable for each project may be simultaneously generated for each of the plurality of new projects. According to the present disclosure, when labeling the data for the plurality of new projects, the data labeling can be performed through the simultaneously generated preprocessing engine, so it is possible to drastically reduce the time and cost required for the data labeling.

However, the effects of the present disclosure are not limited to the above-described effects, and other effects that are not mentioned may be obviously understood by those skilled in the art from the following description.

Although the present disclosure has been described with reference to the exemplary embodiments and the accompanying drawings, it is not limited to the above-mentioned exemplary embodiments but may be variously modified and changed from the above description by those skilled in the art to which the present disclosure pertains. Therefore, the technical idea of the present disclosure should be understood only by the following claims, and all of the equivalences and equivalent modifications to the claims are intended to fall within the technical idea of the present disclosure.

What is claimed is:

1. An automated training-based data labeling method performed by a processor executing one or more instructions stored in memory, comprising:
(a) transmitting a plurality of source data to a worker terminal;
(b) receiving, from the worker terminal, first-round labeled data for which data labeling is performed on objects in first-round source data among the plurality of source data;
(c) generating a first-round artificial intelligence model that automatically performs the data labeling on the objects in the source data by separating some of the first-round labeled data into first-round training data, and training an artificial neural network through the first-round training data;
(d) receiving, from the worker terminal, nth-round labeled data for which the data labeling is performed on objects in nth-round source data among the plurality of source data;
(e) generating an nth-round artificial intelligence model that automatically performs the data labeling on the objects in the source data by separating some of the nth-round labeled data into the nth-round training data, and training an n−1th-round artificial neural model through the nth-round training data; and
(f) determining whether a preset termination condition is satisfied, and repeatedly performing the steps (d) to (e) until the preset termination condition is satisfied, wherein the n is a natural number applied in ascending order from 2 based on the number of times the steps (d) and (e) are performed.

2. The automated training-based data labeling method of claim 1,
wherein the processor is configured to determine a similarity among the source data to be transmitted to the worker terminal according to a preset similarity determination criterion, divide the plurality of source data into rounds according to the similarity among the source data, and transmit the source data to the worker terminal, and
wherein the processor is configured to include source data with low similarity to each other in the first-round source data transmitted to the worker terminal, and include source data with higher similarity than the similarity among source data included in the first-round source data in the nth-round source data transmitted to the worker terminal.

3. The automated training-based data labeling method of claim 2,
wherein the number of source data included in the nth-round source data that the processor transmits to the worker terminal is smaller than the number of source data included in the first-round source data that the processor transmits to the worker terminal.

4. The automated training-based data labeling method of claim 1,
wherein in the step (c), the processor separates the remainder of the first-round labeled data into first-round verification data,
calculates performance of the first-round artificial intelligence model utilizing the first-round verification data, and
determines whether performance of the first-round artificial intelligence model satisfies a preset minimum required performance.

5. The automated training-based data labeling method of claim 4,
wherein when the performance of the first-round artificial intelligence model satisfies the preset minimum required performance, the processor designates the first-round artificial intelligence model as a preprocessing engine and transmits the preprocessing engine to the worker terminal in order to allow the worker to utilize automated data labeling performed by the preprocessing engine when the worker performs data labeling with the worker terminal.

6. The automated training-based data labeling method of claim 4,
wherein when the performance of the first-round artificial intelligence model does not satisfy the preset minimum required performance, the processor does not designate the first-round artificial intelligence model as a preprocessing engine.

7. The automated training-based data labeling method of claim 4,
wherein in the step (e), the processor separates the remainder of the nth-round labeled data into nth-round verification data,
calculates the performance of the first-round artificial intelligence model to the nth-round artificial intelligence model, respectively, utilizing all of the first-round verification data to the nth-round verification data, and
selects an artificial intelligence model with highest performance among the first-round artificial intelligence model to the nth-round artificial intelligence model.

8. The automated training-based data labeling method of claim 7,
wherein the processor determines whether performance of the selected artificial intelligence model satisfies the preset minimum required performance, and
when the performance of the selected artificial intelligence model satisfies the preset minimum required performance, the processor designates the selected artificial intelligence model as a preprocessing engine and transmits the preprocessing engine to the worker terminal in order to allow the worker to utilize automated data labeling performed by the preprocessing engine when the worker performs data labeling with the worker terminal.

9. The automated training-based data labeling method of claim 7,
wherein the processor determines whether performance of the selected artificial intelligence model satisfies the preset minimum required performance, and does not designate the selected artificial intelligence model as a preprocessing engine when the performance of the selected artificial intelligence model does not satisfy the preset minimum required performance.

10. An automated training-based data labeling method performed by a processor executing one or more instructions stored in memory, comprising:
(a′) transmitting a plurality of source data to a worker terminal;
(b′) receiving, from the worker terminal, first-round labeled data for which data labeling is performed on objects in first-round source data among the plurality of source data; and
(c′) generating a first-round artificial intelligence model that automatically performs the data labeling on objects in the source data by separating some of the first-round labeled data into first-round training data and training a prior artificial intelligence model that is pre-trained to automatically perform the data labeling on the objects in the source data through the first-round training data.

11. The automated training-based data labeling method of claim 10,
wherein in the step (c′), the processor separates the remainder of the first-round labeled data into first-round verification data,
calculates performance of the prior artificial intelligence model and the first-round artificial intelligence model, respectively, utilizing the first-round verification data, and
selects an artificial intelligence model with higher performance among the prior artificial intelligence model and the first-round artificial intelligence model.

12. The automated training-based data labeling method of claim 11,
wherein the processor determines whether the performance of the selected artificial intelligence model satisfies a preset minimum required performance, and
when the performance of the selected artificial intelligence model satisfies the preset minimum required performance, the processor designates the selected artificial intelligence model as a preprocessing engine and transmits the preprocessing engine to the worker terminal in order to allow the worker to utilize automated data labeling performed by the preprocessing engine when the worker performs data labeling with the worker terminal.

13. The automated training-based data labeling method of claim 11,
wherein the processor determines whether the performance of the selected artificial intelligence model satisfies a preset minimum required performance, and does not designate the selected artificial intelligence model as a preprocessing engine when the performance of the selected artificial intelligence model does not satisfy the preset minimum required performance.

14. The automated training-based data labeling method of claim 11, further comprising:
after the step (c′), by the processor,
(d′) receiving, from the worker terminal, mth-round labeled data for which the data labeling is performed on objects in mth-round source data among the plurality of source data;
(e′) generating an mth-round artificial intelligence model that automatically performs the data labeling on the objects in the source data by separating some of the mth-round labeled data into the mth-round training data and training an m−1th-round artificial intelligence model through the mth-round training data; and
(f′) determining whether a preset termination condition is satisfied, and repeatedly performing the steps (d′) to (e′) until the preset termination condition is satisfied, wherein the m is a natural number applied in ascending order from 2 based on the number of times the steps (d′) and (e′) are performed.

15. The automated training-based data labeling method of claim 14,
wherein in the step (e′), the processor separates the remainder of the mth-round labeled data into mth-round verification data,
calculates the performance of the prior artificial intelligence model, and the first-round artificial intelligence model to the mth-round artificial intelligence model, respectively, utilizing all of the first-round verification data to the mth-round verification data, and
selects an artificial intelligence model with highest performance among the prior artificial intelligence model, and the first-round artificial intelligence model to the mth-artificial intelligence model.

16. The automated training-based data labeling method of claim 15,
wherein the processor determines whether the performance of the selected artificial intelligence model satisfies a preset minimum required performance, and
when the performance of the selected artificial intelligence model satisfies the preset minimum required performance, the processor designates the selected artificial intelligence model as a preprocessing engine and transmits the preprocessing engine to the worker terminal in order to allow the worker to utilize automated data labeling performed by the preprocessing engine when the worker performs data labeling with the worker terminal.

17. The automated training-based data labeling method of claim 15,
wherein the processor determines whether performance of the selected artificial intelligence model satisfies a preset minimum required performance, and does not designate the selected artificial intelligence model as a preprocessing engine when the performance of the selected artificial intelligence model does not satisfy the preset minimum required performance.
